(19) United States
(12) Patent Application Publication
(10) Pub. No.: US 2011/0164406 A1
(43) Pub. Date: Jul. 7, 2011

(54) WEARABLE ARTICLE CAPABLE OF ILLUMINATION

(75) Inventor: Tommy Chen, Hsintien City (TW)

(73) Assignee: Macpower & Tytech Technology Co., Ltd., Hsintien City (TW)

(21) Appl. No.: 12/683,016

(22) Filed: Jan. 6, 2010

(51) Int. Cl. F21V 21/08; A45C 15/06

(52) U.S. Cl. 362/103; 362/156

(57) ABSTRACT

A bag includes a lamp device that includes a plurality of LED chips disposed spacedly in a tube body of a transparent tube and coupled in parallel between first and second conducting wires of a wire unit, and a power source for supplying electric power to the LED chips through the wire unit. The transparent tube has a connecting flange extending outwardly and radially from an outer surface of the tube body, and clamped and fixed between ends of flexible first and second outer sheets of a bag body such that the tube body is disposed at a junction of the first and second outer sheets.

### BACKGROUND OF THE INVENTION

1. Field of the Invention

The invention relates to a bag to be worn by a person, more particularly to a bag that is capable of illumination.

2. Description of the Related Art

For safety purposes, a wearable bag is usually sewn with light-reflecting sheet elements on its surfaces for providing a light signal by reflecting the light incident from an external light source.

However, as these light-reflecting sheet elements can reflect light only when there is an incident light, they are ineffective in case of lack of a light source.

### SUMMARY OF THE INVENTION

Therefore, the object of the present invention is to provide a bag that can be worn by a person and that is capable of illumination.

According to one aspect of the present invention, there is provided a bag adapted to be worn by a person and capable of illumination. The bag comprises:

a bag body including flexible first and second outer sheets disposed adjacent to each other;

a flexible transparent tube having a tube body having an outer surface, and a connecting flange extending outwardly and radially from the outer surface of the tube body, and clamped and fixed between sides of the first and second outer sheets such that the tube body is disposed at a junction of the first and second outer sheets; and a lamp device including a wire unit disposed in and extending outwardly of the tube body of the transparent body, and including first and second conducting wires isolated electrically from each other,

a lamp unit disposed in the tube body of the transparent tube and including a plurality of light emitting diode (LED) chips spaced apart from each other, each of the LED chips having an anode terminal connected electrically to the first conducting wire of the wire unit, and a cathode terminal connected electrically to the second conducting wire of the wire unit such that the LED chips are coupled in parallel through said wire unit, and

a power source coupled to the lamp unit through the wire unit for supplying electric power to the lamp unit.

According to another aspect of the present invention, there is provided an article adapted to be worn by a person and capable of illumination. The article comprises:

flexible first and second outer sheets disposed adjacent to each other;

a flexible transparent tube having a tube body having an outer surface, and a connecting flange extending outwardly and radially from the outer surface of the tube body, and clamped and fixed between sides of the first and second outer sheets such that the tube body is disposed at a junction of the first and second outer sheets; and

a lamp device including
a wire unit disposed in and extending outwardly of the tube body of the transparent body, and including first and second conducting wires isolated electrically from each other,
a lamp unit disposed in the tube body of the transparent tube and including a plurality of light emitting diode (LED) chips spaced apart from each other, each of the LED chips having an anode terminal connected electrically to the first conducting wire of the wire unit, and a cathode terminal connected electrically to the second conducting wire of the wire unit such that the LED chips are coupled in parallel through the wire unit, and
a power source coupled to the lamp unit through the wire unit for supplying electric power to the lamp unit.

### BRIEF DESCRIPTION OF THE DRAWINGS

Other features and advantages of the present invention will become apparent in the following detailed description of the preferred embodiment with reference to the accompanying drawings, of which:

FIG. 1 is a perspective view showing the preferred embodiment of a wearable article according to this invention;

FIG. 2 is a fragmentary sectional view of the preferred embodiment illustrating how a transparent tube is combined with first and second outer sheets;

FIG. 3 is a perspective view showing a combination of the transparent tube and a lamp device of the preferred embodiment; and

FIG. 4 is a schematic electrical circuit diagram illustrating the lamp device of the preferred embodiment.

### DETAILED DESCRIPTION OF THE PREFERRED EMBODIMENT

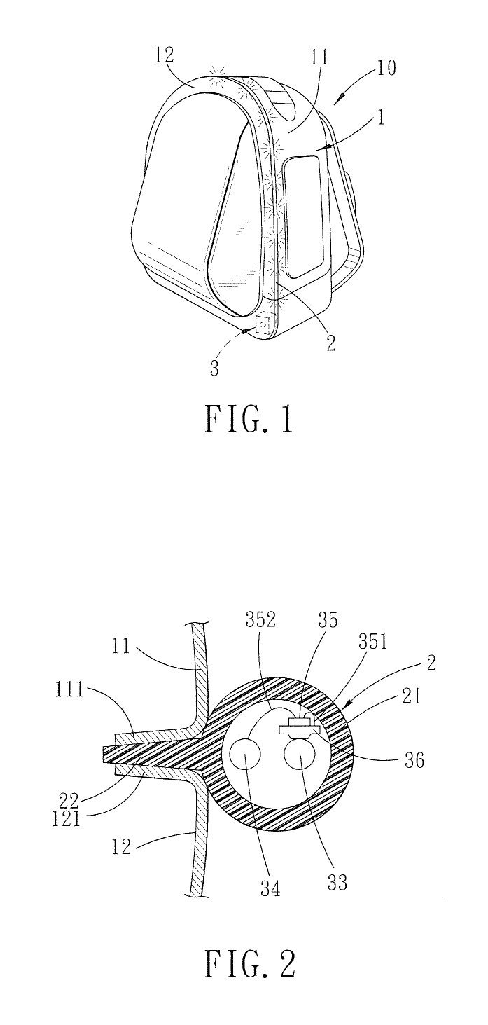

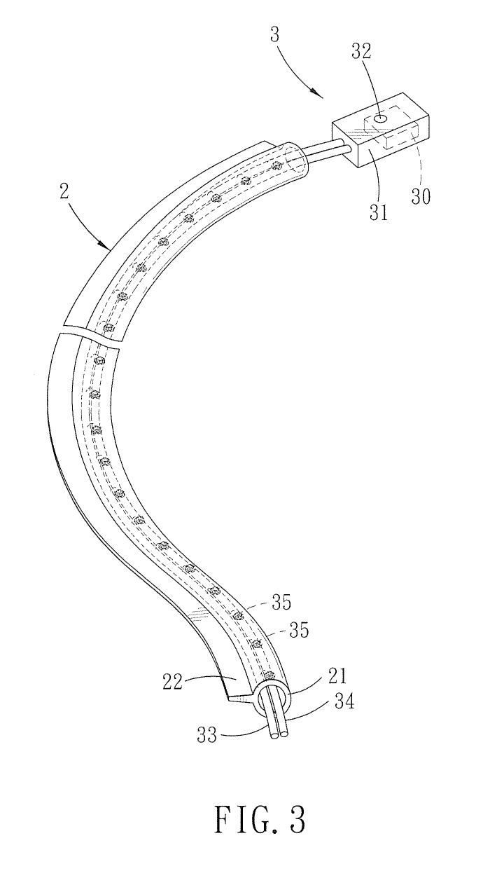

Referring to FIGS. 1 to 3, the preferred embodiment of a wearable article according to the present invention, such as a bag 10 adapted to be worn by a person, is shown to include a bag body 1, a flexible transparent tube 2, and a lamp device 3.

The bag body 1, which is in the form of a backpack in this embodiment, includes flexible first and second outer sheets 11, 12 disposed adjacent to each other.

The transparent tube 2 has a tube body 21 with an outer surface 210, and a connecting flange 22 extending outwardly and radially from the outer surface 210 of the tube body 21, and clamped and fixed between sides 111, 121 of the first and second outer sheets 11, 12 such that the tube body 21 is disposed at a junction of the first and second outer sheets 11, 12. In this embodiment, the transparent tube 2 is made of one of polyvinyl chloride (PVC) and thermoplastic polyurethane (TPU), and has a color similar to that of the bag body 1.

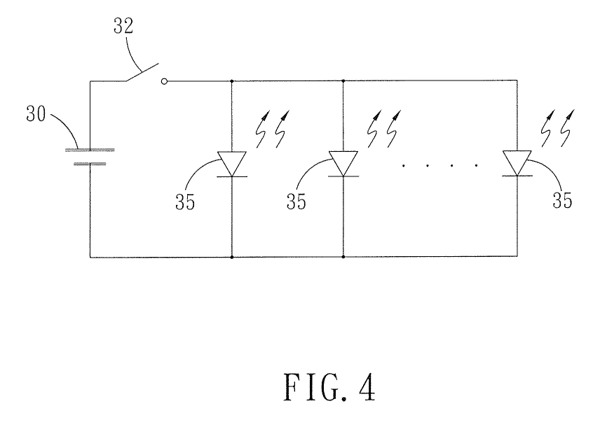

Referring further to FIG. 4, the lamp device 3 includes a wire unit, a lamp unit, a casing 31, a power source 30, and a power switch 32.

The wire unit is disposed in and extends outwardly of the tube body 21 of the transparent tube 2, and includes first and second conducting wires 33, 34 isolated electrically from each other. Preferably, each of the first and second conducting wires 33, 34 is an enamel-insulated wire.

The lamp unit is disposed sealingly in the tube body 21 of the transparent body 2, and includes a plurality of LED chips 35. Each LED chip 35 has an anode terminal 351 connected electrically to the first conducting wire 33 via a mounting seat 36 (see FIG. 2), and a cathode terminal 352 connected electrically to the second conducting wire 34 such that the LED chips 35 are coupled in parallel through the wire unit (see FIG. 4).

The power source 30, which is a battery in this embodiment, is disposed sealingly in the casing 31, and is coupled to the lamp unit through the wire unit for supplying electric power to the lamp unit.

The power switch 32 is mounted on the casing 31, and is coupled between the power source 30 and the lamp unit (see FIG. 4). The power switch 32 is operable so as to control supply of the electric power from the power source 30 to the lamp unit through the wire unit

In sum, due to the presence of the lamp device 3, the wearable bag 10 of the present invention is capable of illumination, thereby actively producing a warning light signal for safety purposes. Furthermore, when illuminating, the bag 10 has an attractive appearance.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A bag adapted to be worn by a person and capable of illumination, comprising:
a bag body including flexible first and second outer sheets disposed adjacent to each other;
a flexible transparent tube having a tube body having an outer surface, and a connecting flange extending outwardly and radially from said outer surface of said tube body, and clamped and fixed between sides of said first and second outer sheets such that said tube body is disposed at a junction of said first and second outer sheets; and
a lamp device including
a wire unit disposed in and extending outwardly of said tube body of said transparent body, and including first and second conducting wires isolated electrically from each other,
a lamp unit disposed in said tube body in said transparent tube and including a plurality of light emitting diode (LED) chips spaced apart from each other, each of said LED chips having an anode terminal connected electrically to said first conducting wire of said wire unit, and a cathode terminal connected electrically to said second conducting wire of said wire unit such that said LED chips are coupled in parallel through said wire unit, and
a power source coupled to said lamp unit through said wire unit for supplying electric power to said lamp unit.

2. The bag as claimed in claim 1, wherein said transparent tube is made of one of polyvinyl chloride (PVC) and thermoplastic polyurethane.

3. The bag as claimed in claim 1, wherein said transparent tube has a color similar to that of said bag body.

4. The bag as claimed in claim 1, wherein each of said first and second conducting wires of said wire unit is an enamel-insulated wire.

5. The bag as claimed in claim 1, wherein said lamp device further includes:
a casing disposed in said bag body for receiving said power source therein; and
a power switch mounted on said casing, coupled between said power source and said lamp unit, and operable so as to control supply of the electric power from said power source to said lamp unit through said wire unit.

6. An article adapted to be worn by a person and capable of illumination, comprising:
flexible first and second outer sheets disposed adjacent to each other;
a flexible transparent tube having a tube body having an outer surface, and a connecting flange extending outwardly and radially from said outer surface of said tube body, and clamped and fixed between sides of said first and second outer sheets such that said tube body is disposed at a junction of said first and second outer sheets; and
a lamp device including
a wire unit disposed in and extending outwardly of said tube body of said transparent body, and including first and second conducting wires isolated electrically from each other,
a lamp unit disposed in said tube body of said transparent tube and including a plurality of light emitting diode (LED) chips spaced apart from each other, each of said LED chips having an anode terminal connected electrically to said first conducting wire of said wire unit, and a cathode terminal connected electrically to said second conducting wire of said wire unit such that said LED chips are coupled in parallel through said wire unit, and
a power source coupled to said lamp unit through said wire unit for supplying electric power to said lamp unit.

7. The article as claimed in claim 6, wherein said transparent tube has a color similar to those of said first and second outer sheets.

8. The article as claimed in claim 6, wherein said lamp device further includes:
a casing for receiving said power source therein; and
a power switch mounted on said casing, coupled between said power source and said lamp unit, and operable so as to control supply of the electric power from said power source to said lamp unit through said wire unit.
